(19) United States
(12) Patent Application Publication
(10) Pub. No.: US 2026/0370660 A1
(43) Pub. Date: Nov. 19, 2026

(54) ARTIFICIAL INTELLIGENCE DRIVEN THREAT DETECTION DURING REMOTE ACCESS TO A COMPUTER

(71) Applicant: Keeper Security, Inc., Chicago, IL (US)

(72) Inventors: Craig B. Lurey, El Dorado Hills, CA (US); Darren Guccione, Chicago, IL (US); Jeremy London, Denver, CO (US); Micah Roberts, Chicago, IL (US)

(21) Appl. No.: 19/206,865

(22) Filed: May 13, 2025

(51) Int. Cl. H04L 9/40; H04L 41/16

(52) U.S. Cl. CPC H04L 63/1416; H04L 41/16; H04L 63/0428

(57) ABSTRACT

A system and method to detect a threat during remote access to an enterprise device are disclosed. A gateway application operates on a gateway device and is adapted to receive a request to access an enterprise device, wherein the request is generated by a client application operating on an end-user device and the end-user device is remote from the access manager device and the gateway device. In addition, the gateway device is adapted to receive an encrypted end-user payload from the client application via a secure peer-to-peer network connection, decrypt the encrypted end-user payload to generate a decrypted end-user payload, and transmit the decrypted end-user payload to the enterprise device. In addition, the gateway application is adapted to provide the decrypted end-user payload to a sentry application. The sentry application is adapted to supply contents of the decrypted end-user payload as input to an artificial intelligence model and, in response, the artificial intelligence model is adapted to generate a threat assessment as an output. The sentry application is further adapted to evaluate the threat assessment and direct the gateway application to close the secure peer-to-peer network connection if the threat assessment is associated with high-risk of malicious activity.

### FIELD OF DISCLOSURE

The present subject matter relates to systems and methods for detecting threats to infrastructure devices and more particularly, a system and method that uses artificial intelligence to detect a threat to an infrastructure device from a remote end-user device.

### BACKGROUND

An enterprise may have one or more infrastructure or enterprise devices (e.g., computer systems) that are installed on-premises at a facility associated with the enterprise or that operate on a cloud computing platform such as, e.g., Amazon AWS, Microsoft Azure, etc. Such enterprise devices may be used to manage the operation of the enterprise and store data associated with such operations. End users, e.g., employees, contracted staff, and other authorized users may be provided access to such enterprise devices to monitor and control the operation thereof, access data stored thereon, and the like. Further, IT administrators and development teams may need access to computers of the enterprise used by other end users such as desktop computers, laptop computers, workstations and the like to support such other end users.

Connection management products such as a Guacamole gateway developed by the Apache Software Foundation, and the like may be installed on the enterprise devices to allow end users to access such enterprise devices from a location remote from an enterprise facility. As would be understood by one having ordinary skill in the art, an end user who may use an end user computer on the same network (i.e., either on the same local area network, via a virtual private network, a zero trust network access service, and the like) may open a browser window on the end user computer that may connect to the connection management product to open a remote desktop session, a secure shell, a virtual network computing viewer, and the like to access and control the infrastructure compute system.

Typically, use of the connection management product requires the end user to have authentication credentials such as login passwords, SSH keys, database credentials, cloud access keys, and the like associated with infrastructure computer systems. Such authentication credentials may be provided to the end user or may be shared among a team of end users to allow such users to access the infrastructure computer system. However, controlling which end users have access to such authentication credentials may become complex as the enterprise scales, end users move to different organization within the enterprise, and/or end users leave the enterprise. Poor credential management in such situations may pose a significant security risk to the enterprise.

In addition, the enterprise may be exposed to additional risks as a result of unauthorized or malicious activity by an end-user such as, for example, using the enterprise device to exfiltrate data stored within the enterprise network, escalate the privileges of the end-user, or undertake other exploits that threaten the security of the enterprise device and other devices operating in the enterprise network.

### SUMMARY

According to one aspect, a system for threat detection during remote access to an enterprise device includes a sentry application, an artificial intelligence model, and a gateway application. The gateway application operates on a gateway device and is adapted to receive a request to access an enterprise device. The request is generated by a client application operating on an end-user device and the end-user device is remote the gateway device. The gateway application is also adapted to receive an encrypted end-user payload from the client application via a secure peer-to-peer network connection, decrypt the encrypted end-user payload to generate a decrypted end-user payload, transmit the decrypted end-user payload to the enterprise device, provide the decrypted end-user payload to the sentry application. The sentry application is adapted to supply contents of the decrypted end-user payload as input to the artificial intelligence model and, in response, the artificial intelligence model is adapted to generate a threat assessment as an output. The sentry application is further adapted to evaluate the threat assessment and direct the gateway application to close the secure peer-to-peer network connection if the threat assessment is associated with high-risk of malicious activity.

According to another aspect, a method for threat detection during remote access to an enterprise device includes receiving by a gateway application a request to access an enterprise device, wherein the request is generated by a client application operating on an end-user device. The method also includes receiving by the gateway application an encrypted end-user payload from the client application via a secure peer-to-peer network connection, decrypting the encrypted end-user payload to generate a decrypted end-user payload, transmitting the decrypted end-user payload to the enterprise device, supplying contents of the decrypted end-user payload as input to the artificial intelligence model and, in response, the artificial intelligence model is adapted to generate a threat assessment as an output. The method also includes evaluating the threat assessment and closing the secure peer-to-peer network connection if the threat assessment is associated with high-risk of malicious activity.

In some embodiments, a secrets manager operates on an access manager device remote from the gateway device, wherein gateway application receives credentials associated with the enterprise device from the secrets manager.

In some embodiments, the gateway manager directs the secrets manager to revoke authentication credentials of an end-user associated with the client application if the threat assessment is associated with high-risk.

In some embodiments, the access credentials are not available to the client application.

In some embodiments, the secure peer-to-peer network connection is in accordance with a WebRTC protocol.

In some embodiments, the gateway application is further adapted to receive an unencrypted enterprise device payload associated with the enterprise, encrypt the unencrypted enterprise device payload, and transmit the encrypted enterprise device payload to the client application via the secure peer-to-peer network connection.

In some embodiments, the sentry application is adapted to supply contents of the unencrypted enterprise device payload as input to the artificial intelligence model and, in response, the artificial intelligence model is adapted to generate a further threat assessment as an output.

In some embodiments, the unencrypted enterprise device payload comprises an image, the sentry application invokes the optical character recognition module to extract text represented in the image, and the sentry application supplies the extracted text to the AI model.

In some embodiments, the sentry application notifies an administrator associated with the enterprise network that the threat assessment is associated with high-risk of malicious activity.

In some embodiments, the AI model comprises a large language model.

Other aspects and advantages will become apparent upon consideration of the following detailed description and the attached drawings wherein like numerals designate like structures throughout the specification.

### BRIEF DESCRIPTION OF THE DRAWINGS

FIG. 1 is a block diagram of a privileged access manager system in accordance with the present application;

FIG. 1A is a block diagram showing components of the privileged access manager system of FIG. 1;

FIG. 1B is a block diagram showing components operating on a gateway device of the privileged access manager system of FIG. 1;

FIG. 2 is a process diagram that shows steps undertaken by the privileged access manager system of FIG. 1 to allow a client application to access an end user device;

FIG. 3 is a process diagram that shows steps undertaken by a client application to establish a secure peer-to-peer network connection with a gateway application of the privileged access manager system of FIG. 1;

FIG. 4 is a process diagram that shows steps undertaken by a gateway application of the privileged access manager system of FIG. 1 to establish a peer-to-peer network connection with a client application;

FIG. 5 is a process diagram that shows steps undertaken by a client application of the privileged access manager system of FIG. 1 to provide a visual session to an enterprise device;

FIG. 6 is a process diagram that shows steps undertaken by a client application of the privileged access manager system of FIG. 1 to provide a tunnel session to an enterprise device;

FIGS. 7 and 7A are connected process diagrams that shows steps undertaken by a gateway application of the privileged access manager system of FIG. 1 to enable a client application to access an enterprise device; and

FIG. 8 is a process diagram that shows steps undertaken by a sentry application of the privileged access manager system of FIG. 1 to assess a threat risk.

### DETAILED DESCRIPTION

Disclosed herein is a privileged access manager (PAM) system that controls remote access from an end-user device to one or more infrastructure or enterprise computer devices or resources in an enterprise network. Further, the PAM system includes a sentry application monitors interactions between the end-user and the enterprise computer devices and uses an artificial intelligence model to determine if such interactions indicate the operator of the end-user device is attempting to undertake actions that are malicious or otherwise pose a threat to the enterprise device or another device in the enterprise network.

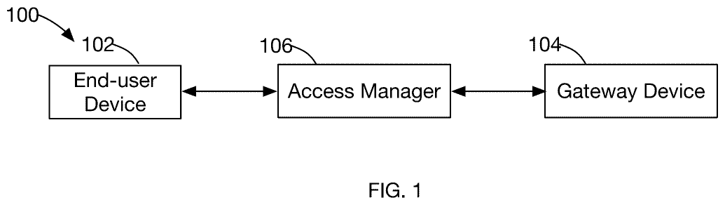

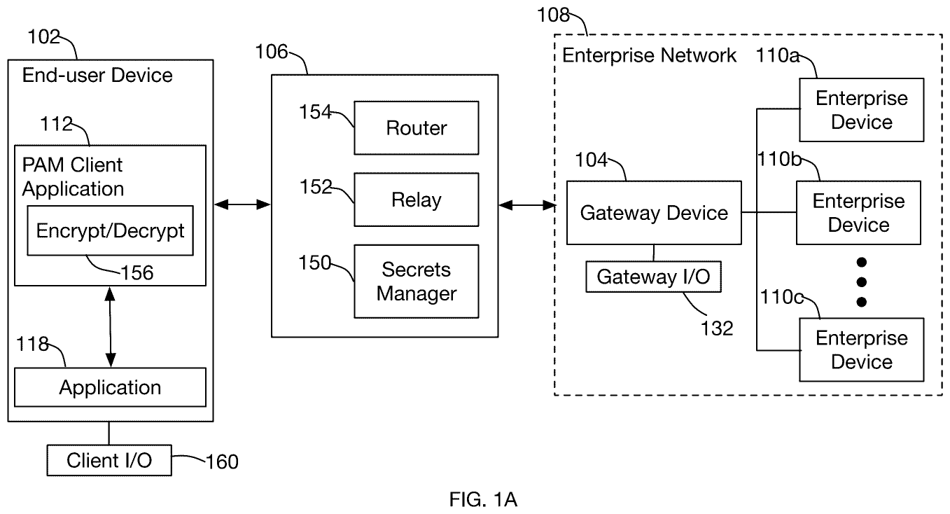

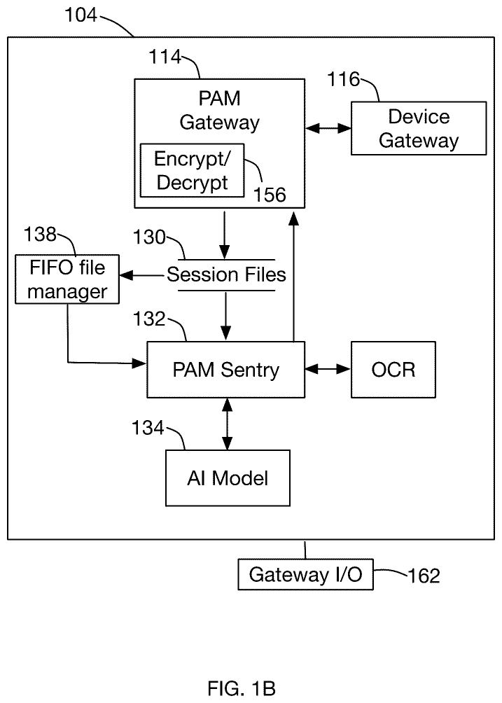

Referring to FIGS. 1, 1A, and 1B, the PAM 100 includes components that operate on an end-user device 102 used by an end-user, a gateway device 104, and an access manager device 106.

In some embodiments, the end-user device 102 may be, for example, a desktop computer, a laptop computer, a mobile computer, and the like operating within an end-user network (not shown) or a public network such as the Internet. The gateway device 104 is a computer operating within an enterprise network 108 and that communicates with one or more enterprise devices 110a, 110b, . . . 110n also operating within the enterprise network 108. The end-user network and the enterprise network 108 may be a local area network, a virtual private network, a network associated with a cloud services provider (e.g., Amazon AWS, Microsoft Azure, etc.), and/or a combination thereof. The one or more enterprise devices 110 may be, for example, desktop, laptop, and/or mobile computers, server computers, database servers, file servers, and the like installed on premises at a facility associated with the enterprise or may be a computer resource provided by a cloud services provider on behalf of the enterprise. The access manager device 106 may also be a computer and communicates with both the end-user device 102 and the gateway device 104 via a public network such as the Internet, a virtual private network, and the like. In some embodiments, the access manager device 106 is installed in a location remote from one or both the end-user device 102 and the gateway device 104. In some embodiments, the access manager device 106 may be provided by a cloud services provider on behalf of an entity separate from the enterprise.

The end-user may use a PAM client application 112 that may be, for example, a desktop application, a web application operating in a web browser (e.g., Chrome developed by Google, Inc., Safari developed by Apple, Inc., Edge developed by Microsoft, Inc., etc.), and the like. It should be apparent to one who has ordinary skill in the art that the term “application” may refer to a standalone application program, a component such as a module of such an application program, an applet or servlet, and the like.

In one embodiment, applications operating on the access manager device 106 facilitate creation of a secure peer-to-peer network connection between the PAM client application 112 and the PAM gateway application 114. Thereafter, the PAM client application 112 enables the end user to request access to the enterprise device 110, displays a remote desktop screen (e.g., a graphical user interface, a command line interface, and the like) generated by the enterprise device 110 on a display associated with the end-user device 102, and receives commands (e.g., mouse movements, text entry, etc.) entered by the end user using an input device (keyboard, mouse, pen, etc.) connected to the end-user device 102. Such commands entered by the end-user are encrypted and transmitted by the PAM client application 112 as encrypted user input data to a PAM gateway application 114 operating on the gateway device 104 via the secure peer-to-peer network connection. The PAM gateway application 114 decrypts the encrypted user input data and provides the decrypted user input data to a device gateway application 116. The device gateway application 116 converts the decrypted user input data into remote desktop control commands in accordance with a protocol associated with the enterprise computer 110, and transmits the remote desktop control commands to the enterprise device 110 and thereby allows the end user to interact with the remote desktop generated by the enterprise device 110.

Similarly, first remote desktop rendering commands that render the remote desktop (e.g., a graphical user interface, a command line interface, and the like) generated by the enterprise device 110 (for example, in response to receipt of the user input data) in accordance with a first protocol associated with the enterprise device 110 are transmitted from the enterprise device 110 to the device gateway application 116. The device gateway application 116 translates the first remote desktop rendering commands in accordance with a second protocol associated with the device gateway application 116 to develop second remote desktop rendering commands and provides second remote desktop rendering commands to the PAM gateway application 114. In some embodiments, such first and second rendering commands may include a sequence of one or more images that represent the desktop of the enterprise device 110. The PAM gateway application 114 encrypts the second remote desktop rendering commands and transmits the encrypted second desktop rendering commands to the PAM client application 112 via the secure peer-to-peer network connection. The PAM client application 112 decrypts the encrypted second desktop rendering commands and interprets the second rendering commands to render a representation of the remote desktop generated by the enterprise device 110 on a display of the end-user device 102.

In some embodiments, the end-user may wish to use an end-user application 118 other than the PAM client application 112 to control an enterprise application operating on the enterprise device 110 (e.g., if the application operating on the enterprise device 110 does not require a graphical user interface and/or does not support remote desktop connections). In such embodiments, the end-user may direct the PAM client application 112 to associate a local network port on the end-user device 102 (“end-user-side network port”) with a network port on the enterprise device 110 (“enterprise-side network port”) monitored by the enterprise application. The end-user-side network port may be opened, written to, and read from by the end-user application 118 as a local network port on the local host (i.e., the host associated with the IP address of the end user device 102). The PAM client application 112 monitors the end-user-side network port and reads any data written thereto, encrypts the data, transmits the encrypted data to the PAM gateway application 114 via the secure peer-to-peer network connection. The PAM gateway application 114 decrypts the data received thereby and transmits such data to the enterprise-side network port of the enterprise device 110 and thus the enterprise application.

Similarly, the PAM gateway application 114 monitors the enterprise-side network port and reads data written to the enterprise-side network port by the enterprise application operating on the enterprise device 110, encrypts such data, and transmits the encrypted data to the PAM client application 112 via the secure peer-to-peer connection. The PAM client application 112 decrypts the encrypted data and writes the decrypted data transmitted by the enterprise application to the end-user-side network port for receipt by the end-user application 118.

In some embodiments, the device gateway application 116 may comprise a clientless remote desktop gateway such as Apache Guacamole developed by the Apache Software Foundation. As should be apparent to one who has ordinary skill in the art, Apache Guacamole translates various desktop rendering protocols (e.g., a Remote Desktop Protocol (RDP) developed by the Microsoft Corporation, a Virtual Network Computing (VNC) protocol, a Secure Shell Protocol (SSH) maintained by the Internet Engineering Task Force, and the like) associated with the enterprise device 110 into rendering commands defined by the Apache Guacamole protocol. The PAM client application 112 interprets the Apache Guacamole rendering commands to recreate the desktop generated by the enterprise device 110 on the client device 102.

In some embodiments, the gateway device 104 may include a session files data store 130, a PAM sentry application 132, and an artificial intelligence (AI) model 134. The PAM gateway application 114 stores in one or more files in the session files data store the decrypted remote desktop control commands generated from the encrypted user data transmitted by the PAM client application 112, the second remote desktop rendering commands generated by the device gateway application 116, the decrypted user data transmitted to the enterprise-side network port by the PAM gateway application 114, and data read from the enterprise-side network port by the PAM gateway application 114. The sentry application 132 reads the contents of the one or more files in the session files data store and provides such contents to the AI model 134. The AI model 134 analyzes the contents and generates an estimate of a risk level that the contents of the session files are associated with unauthorized or malicious actions undertaken by the end user. Such actions may include, for example, attempts to escalate the privilege of the end user or another user, exfiltrate data, install malware, attempts to access devices or resources the end user is not authorized to access, execution of known common vulnerabilities and exposures, and the like. If the risk level exceeds a predetermined level, the sentry application 132 notifies the PAM gateway application 114 to terminate the session with the client application 112, generates an alert sent to an authorized administrator of the enterprise network, and revokes or suspends authorization credentials of the end user to access the enterprise devices 110.

The content in the session files may represent, for example, HTTP/HTTPS data associated with accessing one or more web sites or network resources, RDP, VNC, or SSH data associated with remote desktop access to one or more devices (within the enterprise network 108 or outside the enterprise network 108), database queries to database servers such as MySQL, ProstgreSQL, SQL Server, Oracle, and the like. In some embodiments, if the content in the session files represent an image (e.g., a desktop screen generated during a remote desktop session), the PAM sentry application 132 may use an optical character recognition (OCR) module 136 to identify and extract text represented in the image. In some embodiments, the PAM sentry application 132 supplies the contents in the session files and such extracted text to the AI model 134 to evaluate.

In some embodiments, the AI model 134 may comprise a large language model (LLM) that is trained with examples of cybersecurity incidents and threat patterns to recognize potential breaches based on user interactions, detect if displayed or exfiltrated data contains personally identifiable information, identify misuse of administrative privileges, and the like. In other embodiments, the LLM may be trained to recognize language and contents of images. In some cases, the AI model 134 may comprise a deep neural network or another type of implementation that is trained to recognize cybersecurity threats as may be apparent to one who has ordinary skill in the art. Further, in some embodiments the AI model 134 operates within the enterprise network 108 only and thus unencrypted data represented in contents of the session files are not exposed to devices external to the enterprise network 108.

In some embodiments, the secure peer-to-peer network connection used for communications between the PAM client application 112 and the PAM gateway application 114 is in accordance with the WebRTC protocol (and the Session Description Protocol and Interactive Connectivity Establishment protocols associated with the WebRTC protocol) as defined in “WebRTC: Real-Time Communication in Browsers,” developed by the World Wide Web Consortium (W3C). It should be apparent that embodiments of the PAM 100 need not be limited to using just these protocols and other suitable peer-to-peer communications protocols apparent to one who has ordinary skill in the art may be used in other embodiments.

A secrets manager application 150, a relay application 152, and a router application 154 operate on the access manager device 106. The secrets manager application 150 stores credentials necessary to access the end-user device 102 and enterprise device(s) 110. Such credentials may include, for example, passwords, SSH keys, database credentials, files, and the like associated with such devices. The secrets manager application 150 may comprise, for example, a cloud-hosted Zero-Knowledge vault and associated secret vault server disclosed in Guccione et al., U.S. Patent Appl. No. Ser. No. 17/562,672, entitled “System and Method for Managing Secrets in Computing Environments” and filed Dec. 27, 2021, the entire contents of which are incorporated herein by reference. In such embodiments, the PAM client application 112 may comprise a client-side secret vault and a secrets vault program disclosed in Guccione et al. Other ways of storing and accessing credentials that may be necessary to access the devices associated with the enterprise apparent to one who has ordinary skill in the art may be used in alternate embodiments.

The relay application 152 manages establishing one or more secure, encrypted network connections between the PAM client application 112 and the PAM gateway application 114 operating on the gateway device 104.

As should be apparent from the foregoing, communication between the PAM client application 112 and the PAM gateway application 114 are end-to-end encrypted. Further, because the relay application 152 manages establishing the secure peer-to-peer network connection between the PAM client application 112 and the PAM gateway application 114, no application or service on the end-user device 102 needs to have information (e.g., network address, credentials, and the like) necessary to access the enterprise device 110 or any other device operating in the enterprise network 108 or any applications/services operating on such devices.

In some embodiments, the PAM client application 112 and PAM gateway application 114 use the encryption/decryption services provided by the operating system of the end-user device 102 and the gateway device 104, respectively, and/or communications protocol associated with the secure peer-to-peer network connection therebetween. In other embodiments, the PAM client application 112 and the PAM gateway application 114 may each have an end-user-side and an enterprise-side encryption/decryption module 156 that provides encryption/decryption of data that may be more robust than that provided by such operating systems.

The end-user device 102 may include (or may be coupled to) one more end-user input/output devices 160 that an operating system and application programs operating on the end-user device 102 may use to render content (e.g., via a graphical user interface) viewable by the end-user and to receive input from the end-user. Similarly, the gateway device 104 may include (or may be coupled to) one or more gateway input/output devices 162 that an operating system and/or application programs operating on the gateway device 104 may use to render content and/or receive input from an operator of the gateway device 104. Such end-user and gateway input/output devices 160, 162 may comprise one or more of a display device, a touchscreen device, a tablet or mobile device, a mouse, a keyboard, a trackpad, and other input/output devices apparent to one who has ordinary skill in the art.

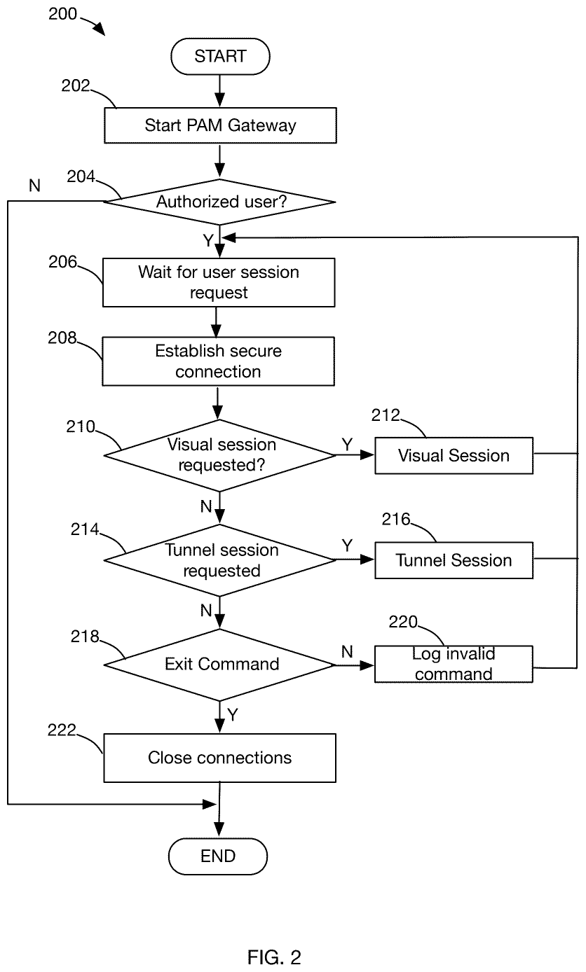

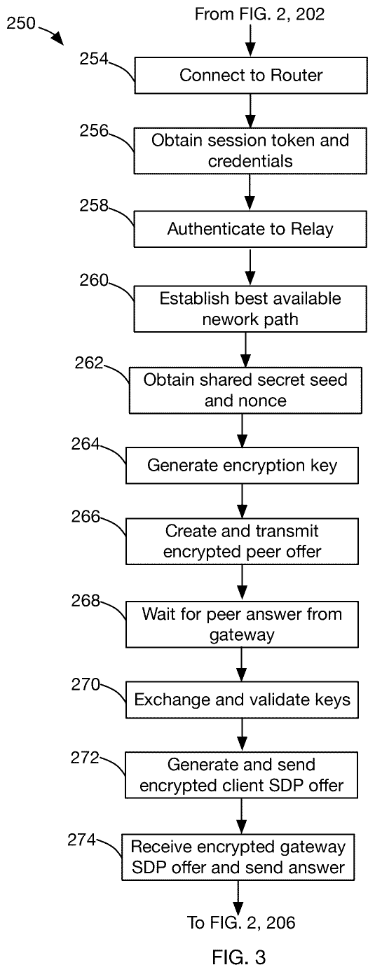

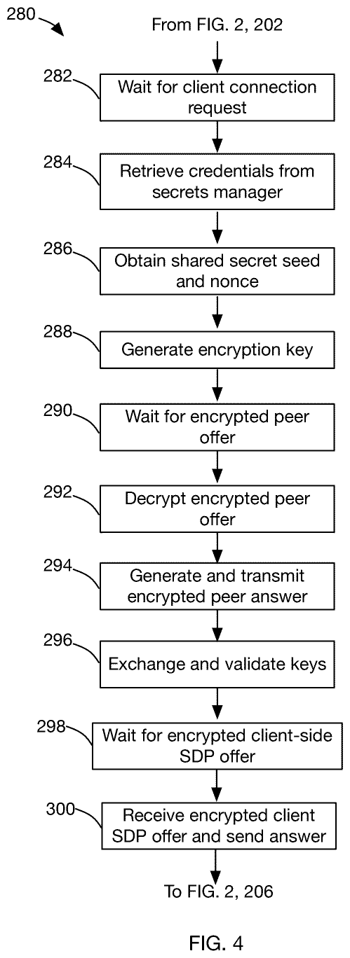

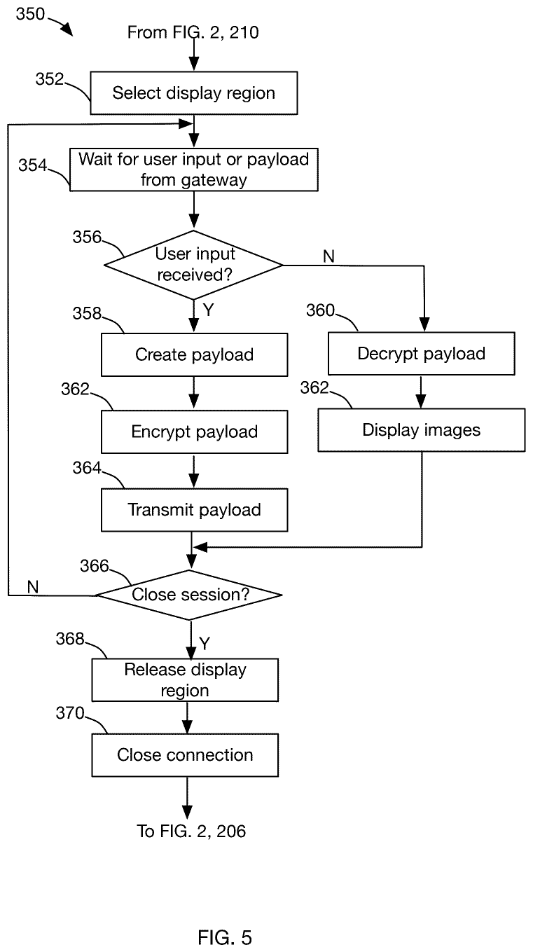

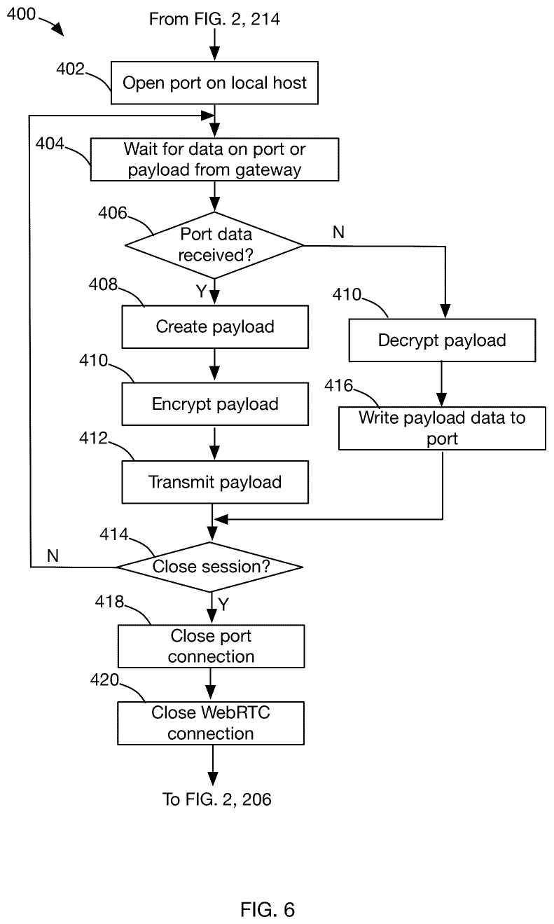

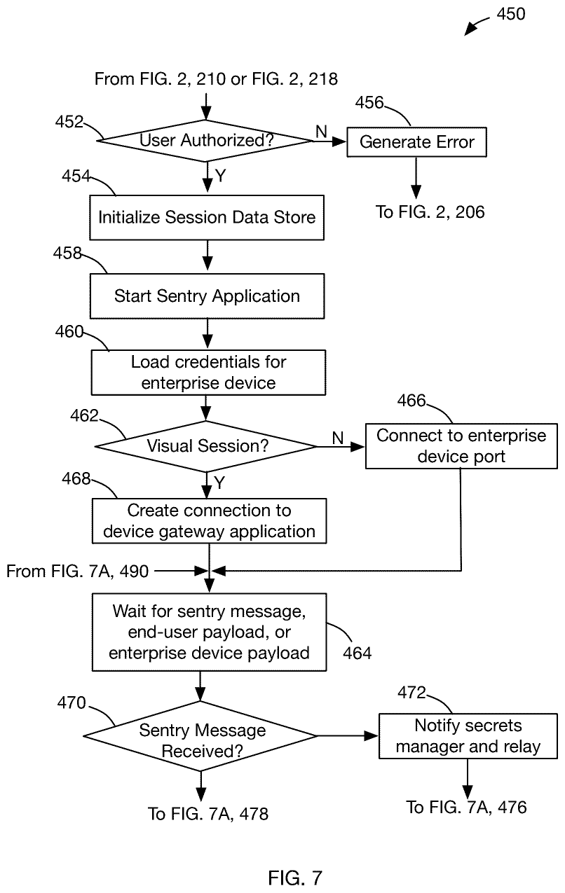

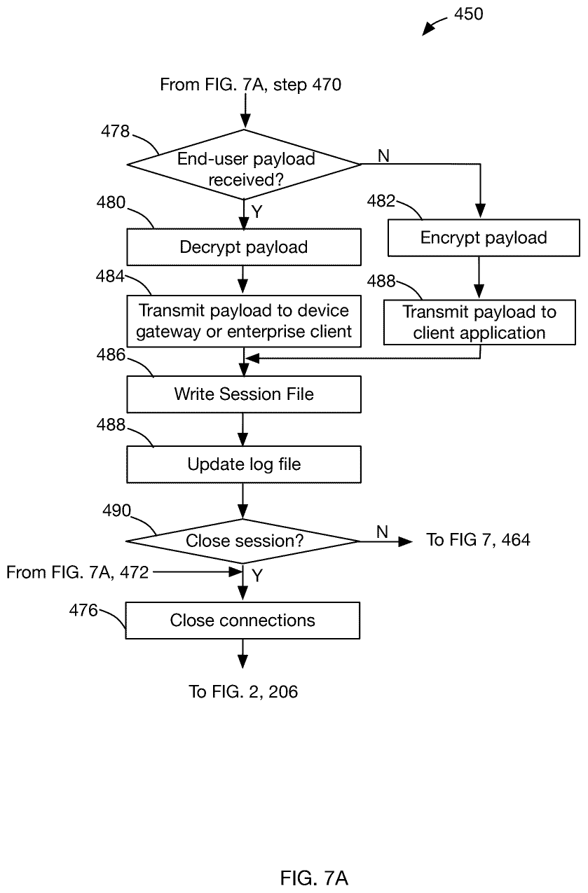

FIG. 2 is a process diagram 200 of the steps undertaken by the PAM 100 to provide the operator of the end-user device 102 access to the enterprise device 110. Referring to FIG. 2, when the PAM gateway application 114 is started by, for example, an authorized operator of the gateway device 104, the PAM gateway application 114, at step 202, opens network connections with the router application 154 and the relay application 152 operating on the access manager device 106 and with the device gateway application 116 operating on the gateway device 104. In addition, the PAM gateway application 114 obtains from the router application 154 a session token and a set of short-lived credentials generated by the router application 154. In some embodiments, the set of short-lived credentials includes a username and a password. The username may include a timestamp that indicates when the session token and/or credentials expire. In some embodiments, the password may be a hash-based message authentication code (HMAC) generated by applying a hash function (e.g., SHA-1) to a pre-shared key stored in a memory of the access manager device 106. The PAM gateway application 114 then uses the username and the password to authenticate with the relay application 152, also at step 202.

Thereafter, when the operator of end-user device 102 launches the PAM client application 112, the PAM client application 112, at step 204, determines if the operator of the end-user device 102 is authorized to use the PAM client application 112 to access any enterprise device 110. In particular, the PAM client application 112 may require the operator to provide predetermined credentials such as a user name and password, may use biometric authentication such as a fingerprint or face scan, and/or multi-factor authentication to authenticate the operator. If the operator is not authorized, the PAM client application 112 exits. In some embodiments, the PAM client application 112 may display an error message that informs the operator that valid authorization is necessary before exiting.

If the operator is an authorized user, at step 206, the PAM client application 112 may display a list of identifiers associated with the enterprise devices 110 and/or applications operating on the enterprises devices 110 the end-user is allowed to access and waits to receive a session request from the operator that identifies a selected enterprise device 110 and whether the session is a remote desktop session (i.e., a visual session) with the selected enterprise device 110 or a secure tunnel network connection between the end-user application 118 operating on the end-user device 102 to the application operating on the selected enterprise device 110. In some embodiments, information regarding the enterprise devices 110 the end user is allowed to access is predetermined and stored in the secrets manager application 150, for example, by an authorized representative of the enterprise. In such embodiments, the PAM client application 112 queries the secrets manager 112 to retrieve the list of identifiers after authenticating the user at step 204 and display such list of identifiers at step 206.

Thereafter, the PAM client application 112 and the PAM gateway application 114 operating in the enterprise network 108 in which the selected enterprise device 110 is operating establish a secure peer-to-peer WebRTC network connection as described in greater detail below at step 208. At step 210, the PAM client application 112 determines if the user session request received at step 206 is a request for a visual (e.g., a remote desktop) session with the selected enterprise devices 110 and, if so, proceeds to step 212. Otherwise, the PAM client application 112 proceeds to step 214.

At step 212, the PAM client application 112 generates and transmits, using the secure peer-to-peer WebRTC network connection, a request to the PAM gateway application 114 to conduct a visual session between the PAM client application 112 and the enterprise device 110 selected by the end user. Thereafter, the PAM client application 112 returns to step 206 to wait for another request from the end user.

At step 214, the PAM client application 112 determines if the request received from the user at step 206 is a request for a tunnel session between the end-user application 118 and the enterprise device 110, and if so, the PAM client application 112 proceeds to step 216. Otherwise, the PAM client application 112 proceeds to step 218.

At step 216, the PAM client application 114 conducts a tunnel session with enterprise device 110 in which the end-user application 118 can securely communicate with an application operating on the enterprise device 110. Thereafter, the PAM client application 112 returns to step 206.

At step 218, the PAM client application 112 determines if the user request received at step 206 is a request to terminate operation of the PAM client application 112. If so, the PAM client application 112 closes any open network connections at step 222 and exits. Otherwise, the end-user request may be another request supported by the PAM client application 112 and the PAM client application 112 undertakes such request at step 220 and returns to step 206.

FIG. 3 is a process diagram 250 of steps undertaken by the PAM client application 112 to create a secure network connection with the PAM gateway application 114, for example, at step 208 of FIG. 2. Referring to FIG. 3, at step 254, the PAM client application 112 opens network connections to the router application 154 and the relay application 152 operating on the access manager device 106. At step 256, the PAM client application 112 obtains from the router application 154, a session token and a set of short-lived credentials generated by the router application 154. As discussed above, the set of short-lived credentials may be similar to those obtained by the PAM gateway application 114 at step 202 (FIG. 2) and include a username and a password. The username may include a timestamp that indicates when the session token and/or credentials expire. In some embodiments, the password may be a hash-based message authentication code (HMAC) generated by applying a hash function (e.g., SHA-1) to a pre-shared key stored in a memory of the access manager device 106.

At step 258, the PAM client application 112 transmits the short-lived credentials received at step 258 to the relay application 152 for authentication and waits for a message from the relay application 152 that the authentication was successful. After such authentication, the PAM client application 112, at step 260, initiates an Interactive Connectivity Establishment (ICE) process to establish a best available network path to use for communications between the PAM client application 112 operating on the end-user device 102 and gateway application 114 operating on the gateway device. In some embodiments, the best available network path may be a network connection through a relay server in accordance with, for example, Traversal Using Relays around NAT (TURN) and Session Traversal Utilities for NAT (STUN) protocols as would be understood by one who has ordinary skill in the art.

At step 262, the PAM client application 112 obtains a 128-bit nonce string and a predetermined secret seed from the secrets manager application 150. At step 264, the PAM client application 112 generates an encryption key (ECDH) from the secret seed and the 128-bit nonce string in accordance with an Elliptic-curve Diffie-Hellman protocol using predetermined domain parameters associated with such protocol. As discussed below, the gateway application 114 also retrieves the 128-bit nonce string and predetermined secret seed and develops an identical encryption key using the 128-bit nonce string, the secret seed, and the predetermined domain parameters.

At step 266, the PAM client application 112 generates a peer offer payload that comprises a WebRTC peer offer payload, encrypts the peer offer payload using the encryption key developed at step 264, and transmits the encrypted peer offer payload to the PAM gateway application 114.

At step 268, the PAM client application 112 waits to receive an encrypted peer answer payload from the PAM gateway application 114. The PAM client application 112 decrypts the encrypted peer answer payload. The decrypted peer answer payload comprises a WebRTC peer answer generated by PAM gateway application 114 in response to successful receipt of the WebRTC peer offer sent at step 264.

At step 270, the PAM client application 112 and PAM gateway application 114 exchange and validate keys in accordance with a Datagram Transport Layer Security (DTLS) protocol and thereby establish a secure peer-to-peer WebRTC network connection therebetween. In some embodiments, the secure peer-to-peer WebRTC network connection comprises public intermediate communications servers identified in accordance with the STUN and/or TURN protocols noted above. Further, in some embodiments, the router application 154 may supply an intermediary TURN relay service between the PAM client application 112 and the PAM gateway application 114 if an optimal path using public servers is not available. As would be understood by one who has ordinary skill in the art, the use of DTLS prevents eavesdropping, tampering, and forgery during communications undertaken using the secure peer-to-peer WebRTC network connection.

At step 272, the PAM client application 112 generates a client-side Session Description Protocol (SDP) offer in accordance with the type of session requested by the operator and such SDP offer may include, for example, a requested protocol to use with the session, codecs that are to be used for the session, network information, encryption keys, and the like. For example, if the session is a remote desktop session, the client-side SDP offer may specify a protocol supported by the device gateway application 116 for such sessions. In some embodiments, if the device gateway application 116 comprises an Apache Guacamole server, the protocol may be Apache Guacamole. The PAM client application 112 encrypts the client-side SDP offer using the ECDH encryption key generated at step 264 and transmits the encrypted client-side SDP offer over the secure peer-to-peer WebRTC network connection to the PAM gateway application 114.

At step 274, the PAM client application 112 waits to receive an encrypted gateway-side SDP offer generated and sent by the PAM gateway application 114 and decrypts the gateway-side SDP offer. As would be understood by one having ordinary skill in the art, the gateway-side SDP offer includes session protocols, codecs, network parameters, and the like supported by the PAM gateway application 114 and/or device gateway application 116. Thereafter, also at step 274, the PAM client application 112 generates a client-side SDP answer, encrypts the SDP answer, and transmits the encrypted SDP answer to the PAM gateway application 114 via the secure peer-to-peer WebRTC network connection. The PAM client application 112 may iterate between steps 272 and 274 to send one or more client side SDP offers/answers and receive one or more gateway-side offers in a negotiation until a session protocol, codecs, and network parameters supported by both the PAM client application 112 and the PAM gateway application 114 are identified.

FIG. 4 is a process diagram 280 of steps undertaken by the PAM gateway application 114 at step 206 (FIG. 2) to establish the secure peer-to-peer WebRTC network connection with the PAM client application 112. It should be understood that PAM client application 112 and the PAM gateway application 114 undertake the steps shown in FIGS. 3 and 4 concurrently during step 204 of FIG. 2. Referring to FIG. 4, at step 282, the PAM gateway application 114 waits to receive a message from the router application 154 that the PAM client application 112 has requested a network connection to an enterprise device 110. The PAM gateway application 114, at step 284, retrieves credentials associated with the enterprise device 110 from the secrets manager application 150. Such credentials may include, for example, administrator credentials, user credentials, and other private data necessary to establish a network connection with and/or operate the enterprise device 110. Note these credentials are not known, available to, or shared with the PAM client application 112, any other application operating on the end-user device 102, or the end user.

At step 286, the PAM gateway application 114 obtains the 128-bit nonce string and the predetermined secret seed from the secrets manager application 150. The 128-bit nonce string and the predetermined secret seed are identical to those obtained by the PAM client application 112 at step 262 (FIG. 3). Thereafter, the PAM gateway application 114 generates an encryption key (ECDH) from the secret seed and the 128-bit nonce string in an identical manner to that used by the PAM client application 112 at step 264 (FIG. 3).

At step 290, the PAM gateway application 114 waits to receive the encrypted peer offer sent by the PAM client application 112 at step 266 (FIG. 3). Upon receipt of the encrypted peer offer, the PAM gateway application 114, at step 292, decrypts the encrypted peer offer.

At step 294, the PAM gateway application 114 generates a peer answer, encrypts the peer answer using the ECDH encryption key generated at step 288, and transmits the encrypted peer answer to the PAM client application 112. The PAM client application 112 receives the encrypted peer answer at step 268 (FIG. 3).

At step 296, the PAM gateway application 114 exchanges and validates keys with the PAM client application 112 in accordance with a Datagram Transport Layer Security (DTLS) protocol and thereby establishes the secure peer-to-peer WebRTC network connection therebetween, as described above in connection with step 270 (FIG. 3) undertaken by the PAM client application 112.

At step 298, the PAM gateway application 114 waits to receive the encrypted client-side SDP offer generated by the PAM client application 112 at step 272 (FIG. 3) via the secure peer-to-peer WebRTC network connection. At step 300, the PAM gateway application 114 generates and sends an encrypted gateway-side SDP offer 300 or an encrypted SDP answer 300 to the PAM client application 112. As discussed above in connection with operation of the PAM client application 112, the PAM gateway application 114 may also iterate steps 298 and 300 to undertake a negotiation in accordance with the WebRTC protocol until a session protocol, codecs, network parameters, and the like supported by both the PAM client application 112 and the PAM gateway application 114 are identified.

FIG. 5 is a process diagram 350 that shows the steps undertaken by the PAM client application 112 at step 212 (FIG. 2) to allow the operator of the end-user device 102 to interact with the selected enterprise computer 110 identified at step 206 (FIG. 2) using a visual session, e.g., a remote desktop session. Referring to FIG. 5, the PAM client application 112, as step 352, selects a region of the display device 160 coupled to the end-user device 102 in which to render the visual session. In some embodiments, the PAM client application 112 creates and renders a window or a dialog box in which the visual session may be rendered. At step 354, the PAM client application 112 waits for receipt of user input from the input device 160 or for an enterprise-device payload generated by the PAM gateway application 116 to be received via the secure peer-to-peer WebRTC network connection described above. At step 356, the PAM client application 112 determines if user input was received and, if so, proceeds to step 358. Otherwise, the PAM client application 112 proceeds to step 360.

At step 358, the PAM client application 112 creates an end-user payload that encodes the received user input into an end-user payload in accordance with the session protocol determined during the exchange of SDP offers and SDP answers at steps 272 and 274 of FIG. 3 and steps 298 and 300 of FIG. 4. As would be apparent to one who has ordinary skill in the art, the user input received at step 356 may represent, for example, movement of a cursor within the window or dialog box using the input device 160 (e.g., using a mouse, trackpad, etc.), selection of a point or region of the window or dialog box using the input device 160, entry of one or more characters using a keyboard, and the like. The end-user payload may include, for example, the type of user input (e.g., keyboard entry, mouse movement, etc.), location of the cursor, changes in location of the cursor, whether a selection button (e.g., a mouse button) is in a clicked state or unclicked state, and the like.

At step 362, the PAM client application 112 encrypts the end-user payload using the ECDH encryption key discussed above and at step 364 the PAM client application 112 transmits the encrypted end-user payload via the secure peer-to-peer WebRTC network connection to the PAM gateway application 114. Thereafter, the PAM client application 112 proceeds to step 366.

If at step 356, the PAM client application 112 determines that user input was not received at step 354 (i.e., an enterprise-device payload generated by the PAM gateway application 114 was received instead), the PAM client application 112 at, step 360, decrypts the received enterprise-device payload. In some embodiments, the enterprise-device payload generated by the PAM gateway application 114 includes a sequence of one or more images that represent the desktop rendered by the selected enterprise device 110 during a predetermined period of time and encoded in accordance with the negotiated session protocol. At step 362, the PAM client application 112 displays in the window or dialog box selected at step 352 the sequence of one or more images encoded in the enterprise-device payload. Thereafter, the PAM client application 112 proceeds to step 366.

At step 366, the PAM client application 112 determines if the user input or the enterprise-device payload generated by the PAM gateway application 114 included an indication that the visual session should be terminated. Such indication may include the user input being associated with closing the window or dialog box associated with the visual session, the enterprise-device payload including an indication that the secure peer-to-peer WebRTC network connection should be closed, and the like.

If, at step 366, the PAM client application 112 determines the session should be closed, the PAM client application 112 proceeds to step 368. Otherwise, the PAM client application 112 proceeds to step 354 to wait for additional user input or an additional enterprise-device payload to be received.

At step 368, the PAM client application 112 closes the window or dialog used to render the visual session and, at step 370, closes the network connection between the PAM client application 112 and the router application 154 and the secure peer-to-peer WebRTC network connection between the PAM client application 112 and the PAM gateway application 114. Thereafter, the PAM client application 112 proceeds to step 206 (FIG. 2) to wait for another user session request.

FIG. 6 is a process diagram 400 of the steps undertaken by the PAM client application 112 at step 216 to conduct a tunnel session between the end-user application 118 operating on the end-user device 102 and an application operating on the selected enterprise device 110. In some embodiments, the user session request received at step 206 (FIG. 2) identifies an end-user-side network port (e.g., a TCP/IP port, a web socket, and the like associated with the “localhost”) associated with the end-user application 118 and an enterprise-side network port associated with the application operating on the enterprise device 110. At step 402, the PAM client application 112 opens a network connection to read and write to the end-user-side network port. At step 404, the PAM client application 112 waits to receive data from the end-user-side network port or an encrypted enterprise-device payload from the PAM gateway application 114 via the secure peer-to-peer WebRTC network connection. At step 406, the PAM client application 112 determines if data was received from the end-user-side network port and, if so, proceeds to step 408. Otherwise, the PAM client application 112 proceeds to step 410.

At step 408, the PAM client application 112 reads data available at the end-user-side network port and creates an end-user payload comprising such data in accordance with the negotiated session protocol. Thereafter, the PAM client application 112 encrypts the end-user payload at step 410 and transmits the encrypted end-user payload to the PAM gateway application 114 via the secure peer-to-peer WebRTC network connection at step 412. The data available at the end-user-side network port may be data provided to the end-user application 118 by the end-user using the input device 160 or may be data generated by the end-user application 118. The PAM client application 112 then proceeds to step 414.

If, at step 406, the PAM client application 112 determines that data was not received at the end-user-side network port (i.e., an encrypted enterprise-device payload was received from the PAM gateway application 114 instead), the PAM client application 112 reads the encrypted enterprise-device payload from the secure peer-to-peer WebRTC network connection and decrypts the encrypted enterprise-device payload at step 410. At step 416, the PAM client application 112 writes the data encoded in the decrypted enterprise-device payload to the end-user-side network port and then proceeds to step 414.

At step 414, the PAM client application 112 determines if the data received at the end-user-side network port or the enterprise-device payload received from the PAM gateway application 114 indicates the tunnel session is to be terminated and, if so, proceeds to step 418. Otherwise, the PAM client application 112 proceeds to step 404. At step 418, the PAM client application 112 closes the network connection to the end-user-side network port and, at step 420, closes the secure peer-to-peer WebRTC network connection. Thereafter, the PAM client application 112 proceeds to step 202 (FIG. 2).

FIGS. 7 and 7A is a process diagram 450 of the steps undertaken by the PAM gateway application 114 in to conduct a visual session at step 212 of FIG. 2 or a tunnel session at step 216 of FIG. 2 between the PAM client or end-user applications 112, 118, respectively, operating on the end-user device 102 and the enterprise device 110 specified in the user session request at step 206 of FIG. 2. Note that the PAM gateway application 114 undertakes the steps shown in FIG. 7 and the PAM client application 112 undertakes the steps shown in FIG. 5 concurrently during step 212 of FIG. 2 is a visual session is being conducted. Alternately, the PAM gateway application 114 undertakes the steps shown in FIG. 7 and the PAM client application 112 undertakes the steps shown in FIG. 6 concurrently during step 216 of FIG. 2 if a tunnel session is being conducted.

At step 452, the PAM gateway application 114 queries the secrets manager application 150 to confirm the PAM client application 112, the end-user device 102, and the end-user are authorized to access the enterprise device 110 and, if so, proceeds to step 454. Otherwise, at step 456, the PAM gateway application 114 generates and transmits a message to the PAM client application 112 that access is not permitted and returns to step 206, FIG. 2. In some embodiments, the PAM gateway application 114 may create an entry in a log file that a visual or tunnel session with the enterprise device 110 was requested and denied, also at step 456.

At step 454, the PAM gateway application 114 initializes the sessions data store 130. In some embodiments, the PAM gateway application 114 may create a directory in which to store session files associated with the current session. In other embodiments, the sessions data store 130 may be associated with a first-in-first-out (FIFO) file manager 138 that is configured to transmit to the PAM sentry application 132 session files created in the session data store 130 in a FIFO order.

At step 458, the PAM gateway application 114 starts the PAM sentry application 132 and opens a network connection or port with the PAM sentry application 132 via which the PAM sentry application 132 and the PAM gateway application 114 may communicate. In addition, the PAM gateway application, also at step 456, configures the PAM sentry application 132 with information where the session files are to be stored within the session data store 130 and/or the FIFO file manager that will provide files to the PAM sentry application 132. In addition, the PAM gateway application 114 may transmit information to the PAM sentry application 132 regarding the end-user device 102 and identification information associated with the end-user, also at step 456.

At step 460, the PAM gateway application 114 loads the credentials (e.g., user name and password, certificate, and the like) from the secrets manager application 150 necessary to access the enterprise device 110. Because the PAM gateway application 114 loads the credentials necessary to access the enterprise device 110 from the secrets manager application 150, the user of the end-user device 102 and no application (e.g., the PAM client application 112, the end-user application 118, and the like) operating on the end-user device 102 need to have access to such credentials. Further, such credentials do not need to be store in a memory of the end-user device 102 or other memory accessible to the end-user device 102 or the end user. Isolating the credentials in this manner from the end-user and the end-user device 110 may protect enterprise devices 110 (and other devices) operating in the enterprise network 108 from unauthorized access. Further, the credentials associated with the enterprise devices 110 may be readily changed without having to notify various end-users who are authorized to have access to the enterprise devices 110 of such change.

Thereafter, at step 462, the PAM gateway application 114 determines if a visual session is being conducted. If a visual session is being conducted, the PAM gateway application 114 at step 464 opens a network connection to the device gateway application 116 and sends a request, including the credentials loaded at step 460, to the device gateway application 116 to initiate a remote desktop session with the enterprise device 110 specified in the user session request. Otherwise (i.e., if a tunnel session is being conducted), the PAM gateway application 114, at step 466, opens a connection to the enterprise-side network port on the enterprise device 110 specified in the user session request and authenticates with the enterprise device 110 using the credentials loaded at step 460.

After undertaking step 464 or step 466, the PAM gateway application 114 proceeds to step 468 and waits to receive a message from the PAM sentry application 132, an encrypted end-user payload generated by the PAM client application 112 via the secure peer-to-peer WebRTC connection, or an enterprise-device payload generated by the enterprise device 110 via the enterprise-side network port.

At step 470, the PAM gateway application 114 determines if a message was received from the PAM sentry application 132 that indicates that the user may be undertaking a malicious or unauthorized action and if so proceeds to step 472. Otherwise, the PAM gateway application 114 proceeds to step 478.

At step 472, the PAM gateway application 114 sends a message to the secrets manager application 150 authorization credentials for the end user to access the enterprise devices 110 in the enterprise network 108 should be revoked. In response the secrets manager application 150 revokes the authorization credentials so further attempts by the end user to access the devices in the enterprise network 108 via the PAM gateway application 114 will be denied, for example, at step 452. Such authorization may remain revoked until reinstated by authorized administrator associated with enterprise network 108. Thereafter, at step 476, the PAM gateway application 114 closes the secure peer-to-peer WebRTC connection with the client application 112 and the network connection with the device gateway application 116 or the enterprise device 110, and returns to step 206 of FIG. 2.

At step 478 (FIG. 7A), the PAM gateway application 114 determines if an encrypted end-user payload has been received and, if so, proceeds to step 480. Otherwise, the PAM gateway application 114 proceeds to step 482.

At step 480, the PAM gateway application 114 decrypts the encrypted end-user payload and, at step 484, transmits the decrypted end-user payload to the device gateway application 116 if a visual session is being conducted or the enterprise-side network port of the enterprise computer 110 if a tunnel session is being conducted. Thereafter, the PAM gateway application 114 proceeds to step 486.

At step 482 (i.e., the PAM gateway application 114 determined that the enterprise-device payload received at step 464 was from the device gateway application 116 or the enterprise-side network port of the enterprise computer 110), the PAM gateway application 114 encrypts the received enterprise-device payload, transmits the encrypted enterprise-device payload to the PAM client application 112 via the secure peer-to-peer WebRTC connection, at step 488, and proceeds to step 486.

At step 486, the PAM gateway application 114 records the contents of the decrypted end-user payload or enterprise-device payload received at step 464 into a session file in the sessions file data store 130. In some embodiments, the PAM gateway application 114 may create a session file each time an end-user or enterprise-device payload is received at step 464. In other embodiments, the PAM gateway application 114 may create a sequence of a time-based session files, wherein each time-based session file is associated with a period of time (e.g., a few microseconds, a few seconds, a few minutes, etc.) and includes decrypted contents of the end-user payload or the enterprise-device payload received during the period of time associated with the time-based session file.

At step 488, the PAM gateway application 114 records the contents of the decrypted end-user payload, the enterprise-device payload received from the device gateway application 116, or the enterprise-device payload received from the enterprise computer 110 into a log file (which may be identical to the log file written to in step 456) stored in a memory of the gateway device 104. Thereafter, the PAM gateway application 114 proceeds to step 490. The log file may be created by the PAM gateway application 114 each time a visual session or tunnel session is initiated. Alternately, the log file may be saved to a backup periodically and thereafter cleared. In some embodiments, if the enterprise-device payload received from the enterprise computer 110 includes a sequence of images, the PAM gateway application 114 may store such sequence of images in the memory (e.g., a disk drive) of the gateway device 104 and add a reference (e.g., a file path, a file name, a Uniform Resource Identifier, and the like) to the sequence of images to the log file. An authorized user associated with the enterprise may review one or more such log files to, for example, determine users who are utilizing the PAM system 100, address connectivity and/or access issues encountered by an end-user, evaluate security and/or performance issues that may arise, and the like.

At step 490, the PAM gateway application 114 determines if the end-user or enterprise-device payload received at step 464 indicates the visual session or the tunnel session should be terminated and if so, closes the network connection to the device gateway application 116 or the enterprise device 110 at step 476, respectively, and returns to step 206 of FIG. 2.

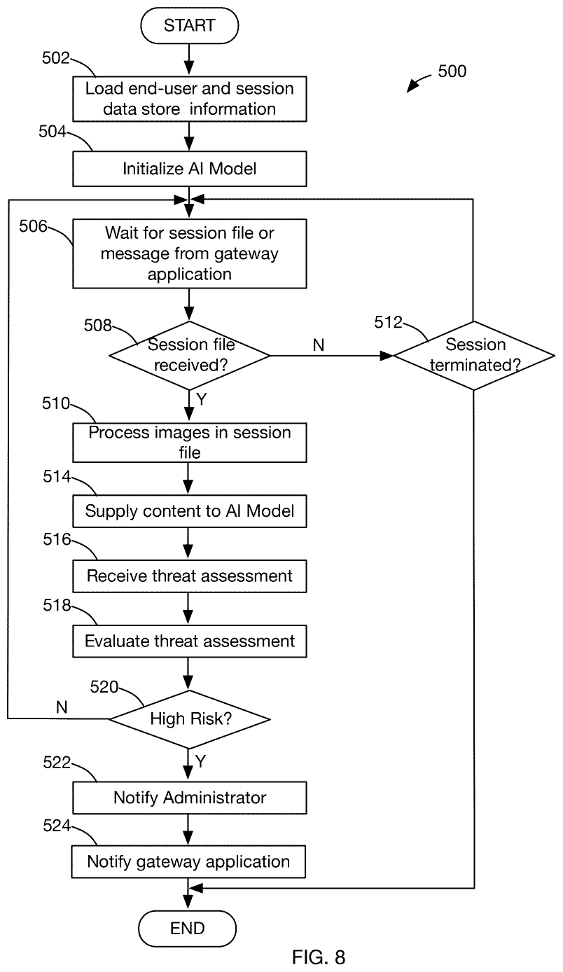

FIG. 8 is a process diagram 500 of the steps undertaken by the PAM sentry application 132 to monitor interactions between the end user and the enterprise device 110. The PAM sentry application 132 operates concurrently with the PAM gateway application 114. At step 502, the PAM sentry application 132 loads the end user information and sessions files data store 130 provided by the PAM gateway application 114 at step 458.

At step 504, the PAM sentry application 132 initializes the AI model 134. In some embodiments, the PAM sentry application 132 may load predetermined configuration parameters developed during training of the AI model 134 to initialize the AI model 134, as would be understood by one who has ordinary skill in the art.

At step 506, the PAM sentry application 132 waits for a session file, e.g., to be stored in the session file data store 130 or provided by the FIFO file manager 138. At step 508, the PAM sentry application 132 determines if a session file was received at step 506 and if so proceeds to step 510. Otherwise, the PAM sentry application 132 proceeds to step 512.

At step 510, the PAM sentry application 132 processes any images in the session file. In particular, the PAM sentry application 132 extracts each image and invokes the OCR module 136 with the extracted image as input to detect and extract any text represented in the image. Thereafter at step 514, the PAM sentry application 132 supplies the contents of the session file and any text extracted at step 510 to an input of the AI model 134. At step 516, the PAM sentry application 132 waits to receive a threat assessment developed at one or more outputs of the AI model 134. In some embodiments, such threat assessment is a probability the content in the session file indicates the end user is undertaking a malicious action. In other embodiments, the output of the AI model 134 may indicate a high-, medium-, or low-risk that the end user is undertaking a malicious action. Alternate ways of indicating a level of threat by the AI model 134 apparent to one who has ordinary skill in the art may be used in other embodiments. In some embodiments, the AI model 134 may generate a summary of the session files (e.g., if the AI model 134 comprises an LLM) that caused the AI model 134 to develop the risk level that the end user may be undertaking a malicious or unauthorized action.

At step 518, the PAM sentry application 132 evaluates the threat assessment received from the AI model 132. If the output of the AI model 134 is associated with a high probability that the end user is undertaking a malicious action, the PAM sentry application 132 may determine that the enterprise network 108 is exposed to a high level of risk.

However, in some embodiments, the PAM sentry application 132 may determine, at step 518, that the enterprise network 108 is exposed to a high level of risk at step 520 even if the output of the AI model 132 at step 516 indicates a moderate probability that the end user is undertaking a malicious action. For example, if such moderate probability has been developed repeatedly at least a predetermined number of times in response to the AI model 132 being supplied with content from a plurality of sequential session files or if a quantity of threat assessments associated with moderate risk are developed by the AI model 134 during the current session exceeds a predetermined value.

At step 520, the PAM sentry application 132 determines if the threat assessment evaluation undertaken at step 518 indicates a high level of risk and, if so proceeds to step 522. Otherwise, the PAM sentry application 132 proceeds to step 506.

At step 522, the PAM sentry application 132 generates a message (e.g., an email message, an SMS message, a text message, and the like) to an administrator device (e.g., a computing device, a cell phone, and the like) operated by an administrator (or other authorized person) that the high level of risk has been identified. Such message may include, for example, the summary generated by the AI model 134, the end user associated with the session being conducted loaded at step 502, a timestamp, and the like.

Thereafter, at step 524, the PAM sentry application 132 generates a message to notify the gateway application 114 that the user may be undertaking malicious or unauthorized actions. and exits.

At step 512 (i.e., if a session file is not received at step 508), the PAM sentry application 132 determines if a message was received form the gateway application 114 that the session should be terminated (or if the gateway application 114 closed the network connection with the PAM sentry application 132) and, if so, the PAM sentry application 132 exits. Otherwise, the PAM sentry application proceeds to step 506.

It should be apparent to those who have skill in the art that any combination of hardware and/or software may be used to implement components of the PAM system 100 described herein. It will be understood and appreciated that one or more of the processes, sub-processes, and process steps described in connection with FIGS. 1-8 may be performed by hardware, software, or a combination of hardware and software on one or more electronic or digitally-controlled devices. The software may reside in a software memory (not shown) in a suitable electronic processing component or system such as, for example, one or more of the functional systems, controllers, devices, components, modules, or sub-modules depicted in FIGS. 1 and 1A. The software memory may include an ordered listing of executable instructions for implementing logical functions (that is, “logic” that may be implemented in digital form such as digital circuitry or source code, or in analog form such as analog source such as an analog electrical, sound, or video signal). The instructions may be executed within a processing module or controller (e.g., the PAM client application 112, the PAM gateway application 114, the device gateway application 116, the end-user application 118, the PAM sentry application 132, the AI model 134, the OCR module 136, the secrets manager application 150, the relay application 152, the router application 154, the client encryption/decryption module 156, and the like), which includes, for example, one or more microprocessors, general purpose processors, combinations of processors, digital signal processors (DSPs), field programmable gate arrays (FPGAs), application-specific integrated circuits (ASICs), and/or graphics processing units (GPUs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

Depending on certain implementation requirements, the embodiments described can be implemented in hardware and/or in software. The implementation can be performed using a non-transitory storage medium such as a digital storage medium, for example, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments may comprise a data carrier having electronically readable control signals, which are capable of cooperating with a processor, a controller, or a programmable computer system, such that one of the methods described herein is performed.

Generally, embodiments disclosed herein can be implemented as a computer program product with a program code, the program code being operative for performing one of the methods when the computer program product runs on a computer. The program code may, for example, be stored on a machine-readable carrier.

Other embodiments comprise the computer program for performing one of the methods described herein, stored on a machine-readable carrier.

In other words, an embodiment, therefore, may include a computer program having a program code for performing one of the methods described herein, when the computer program runs on a processor, a controller, and/or a computer.

While particular embodiments of the present invention have been illustrated and described, it would be apparent to those skilled in the art that various other changes and modifications can be made and are intended to fall within the spirit and scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

We claim:

1. A system for threat detection during remote access to an enterprise device, comprising:
a sentry application;
an artificial intelligence model; and
a gateway application operating on a gateway device wherein the gateway application is adapted to:
receive a request to access an enterprise device, wherein the request is generated by a client application operating on an end-user device and the end-user device is remote from the gateway device;
receive an encrypted end-user payload from the client application via a secure peer-to-peer network connection;
decrypt the encrypted end-user payload to generate a decrypted end-user payload;
transmit the decrypted end-user payload to the enterprise device; and
provide the decrypted end-user payload to the sentry application;
wherein the sentry application is adapted to supply contents of the decrypted end-user payload as input to an artificial intelligence model and, in response, the artificial intelligence model is adapted to generate a threat assessment as an output;
wherein the sentry application is further adapted to evaluate the threat assessment and direct the gateway application to close the secure peer-to-peer network connection if the threat assessment is associated with high-risk of malicious activity.

2. The system of claim 1, further including a secrets manager operating on an access manager device remote from the gateway device, wherein gateway application receives access credentials associated with the enterprise device from the secrets manager.

3. The system of claim 2, wherein the gateway application directs the secrets manager to revoke authentication credentials of an end-user associated with the client application if the threat assessment is associated with high-risk.

4. The system of claim 2, wherein the access credentials are not available to the client application.

5. The system of claim 1, wherein the secure peer-to-peer network connection is in accordance with a WebRTC protocol.

6. The system of claim 1, wherein the gateway application is further adapted to receive an unencrypted enterprise device payload associated with the enterprise device, encrypt the unencrypted enterprise device payload to develop an encrypted enterprise device payload, and transmit the encrypted enterprise device payload to the client application via the secure peer-to-peer network connection.

7. The system of claim 6, wherein the sentry application is adapted to supply contents of the unencrypted enterprise device payload as input to the artificial intelligence model and, in response, the artificial intelligence model is adapted to generate a further threat assessment as an output.

8. The system of claim 7, further including an optical character recognition module, wherein the unencrypted enterprise device payload comprises an image, the sentry application invokes the optical character recognition module to extract text represented in the image, and the sentry application supplies the extracted text to the artificial intelligence model.

9. The system of claim 1, wherein the sentry application notifies an administrator associated with an enterprise network that the threat assessment is associated with high-risk of malicious activity.

10. The system of claim 1, wherein the artificial intelligence model comprises a large language model.

11. A method for threat detection during remote access to an enterprise device, comprising:
receiving by a gateway application a request to access an enterprise device, wherein the request is generated by a client application operating on an end-user device;
receiving by the gateway application an encrypted end-user payload from the client application via a secure peer-to-peer network connection;
decrypting the encrypted end-user payload to generate a decrypted end-user payload;
transmitting the decrypted end-user payload to the enterprise device;
supplying contents of the decrypted end-user payload as input to an artificial intelligence model and, in response, the artificial intelligence model is adapted to generate a threat assessment as an output; and
evaluating the threat assessment and closing the secure peer-to-peer network connection if the threat assessment is associated with high-risk of malicious activity.

12. The method of claim 11, further including operating the gateway application on a gateway device, receiving access credentials associated with the enterprise device by the gateway application from a secrets manager operating on an access manager device remote from the gateway device.

13. The method of claim 12, further including revoking authentication credentials of an end-user associated with the client application if the threat assessment is associated with high-risk.

14. The method of claim 12, wherein the access credentials are not available to the client application.

15. The method of claim 11, wherein the secure peer-to-peer network connection is in accordance with a WebRTC protocol.

16. The method of claim 11, further including receiving an unencrypted enterprise device payload associated with the enterprise device, encrypt the unencrypted enterprise device payload to develop an encrypted enterprise device payload, and transmit the encrypted enterprise device payload to the client application via the secure peer-to-peer network connection.

17. The method of claim 16, further including supplying contents of the unencrypted enterprise device payload as input to the artificial intelligence model and, in response, the artificial intelligence model is adapted to generate a further threat assessment as an output.

18. The method of claim 17, further including invoking an optical character recognition module to extract text represented in an image associated with enterprise device payload and supplying the extracted text to the artificial intelligence model.

19. The method of claim 16, wherein the decrypted end-user payload and the unencrypted enterprise device payload are associated with a remote desktop session.

20. The method of claim 11, wherein the artificial intelligence model comprises a large language model.
